(19) United States
(12) Patent Application Publication
(10) Pub. No.: US 2016/0097370 A1
(43) Pub. Date: Apr. 7, 2016

(54) High-torque wind turbine

(71) Applicants: James L. Rodgers, Mesa, AZ (US); Barry H. Soloway, Oro Valley, AZ (US)

(72) Inventors: James L. Rodgers, Mesa, AZ (US); Barry H. Soloway, Oro Valley, AZ (US)

(21) Appl. No.: 13/986,035

(22) Filed: Mar. 26, 2013

(51) Int. Cl. F03D 1/04; F03D 1/06; F03D 9/00

(52) U.S. Cl. CPC F03D 1/04; F03D 9/002; F03D 9/001; F03D 1/0691

(57) ABSTRACT

A high-torque turbine system receives and converts low to higher speed wind or airflow into mechanical work or electric power; consisting of a number of sail or airfoil blades or blade portions located near the outer periphery having extended moment arms for increased torque, that rotate around an center axis that is parallel to the airflow, wherein the blades receive wind directly, from a center deflector that directs wind received in the center outward to the blades, or from airflow directed externally from man-made, natural or structural sources, wherein the turbine system outputs mechanical work or electrical power.

### RELATED APPLICATIONS

The present application is a continuation-in-part application of U.S. provisional patent application, Ser. No. 503027981, filed Mar. 30, 2012, for HIGH-TORQUE WND TURBINE, by James L. Rodgers, Barry H. Soloway, included by reference herein and for which benefit of the priority date is hereby claimed.

### FIELD OF THE INVENTION

The present invention relates to wind or airflow driven turbines and, more particularly, to a propeller type horizontal axial-flow high-torque wind turbine, having a mechanical or an electrical generator output, with increased torque and efficiency at low-to moderate wind speeds.

### BACKGROUND OF THE INVENTION

Prior wind axial-flow turbines with a generator output typically employ two to five narrow airfoil propeller-type blades that rotate perpendicularly around an axis. The propellers face the wind or airflow in order for them to receive and convert its kinetic energy into electrical power.

The blades are generally made as long as practicable to benefit from a large wind receiving or capture area. They typically need to be placed as high above the ground as practical in order to catch the increased and more stable wind that commonly occurs.

In addition, the turbines, particularly very large ones, are often located or placed on or near the top or passes of mountains in order to capture wind that is higher than in more geographically accessible areas. This is done in order to benefit from wind, airflow or wind shear that has been directed, channeled or otherwise increased in speed or pressure.

Other extremely large turbines are sometimes mounted in the ocean in order to receive typically higher wind speeds without obstructions and without creating noise in occupied areas.

However, these prior turbines have significant limitations that limit their performance at low-wind speeds, particularly wind speeds of 12 to 15 mph or less. In addition, the winds speeds in most geographical accessible areas are much lower than in certain targeted areas or at high heights as described above.

The design of very large turbines is significantly driven by the need to withstand very high winds that occur such as during a storm. They generally need to control the rotational or pitch angle of each blade in order to optimize operation at different wind speeds and help protect the turbine during storms.

In addition, the blades are made wider at their base and narrower at their tips, both to account for the difference in their rotational speed and for strength to support the blades. The blades have a wider area and greater angle near their base or axis to optimize their torque while rotating at a lower speed than the blade tips.

Therefore, the few blades in large turbines are generally a necessary and significant design compromise due to limited blade mounting area, extreme hub loading and blade angle control requirements. This is particularly true in order to survive storms, which in turn limits their potential power output, particularly at lower wind speeds.

The few blades in small turbine are also generally limited by the some of the same factors, although not to the extremes of large turbines having significantly greater weight and wind force.

The resulting few blades in both large and small turbines limit their performance, particularly at lower wind speeds. The amount of torque generated by the blade portions near the axis is limited by their airfoil or sail blade effectiveness and the short length of their moment arm relative to the turbine axis.

The blade portions farther away from the axis operate at higher speed for greater efficiency and with a longer moment arm and thereby provide greater torque in turning the axis. However, their few numbers and small cross-sectional area to the wind force limit overall performance, particularly at low to moderate wind speeds.

In the past, a common example design of a moderately large wind powering turbine or windmill, using large sail-like blades, where the wind essentially push the blades, was used in Holland for many years to pump water, grind materials or do other mechanical work.

Also, in the past, another common example of a small to moderate size turbine with sail-like blades, were the common windmills that had numerous wood or metal blades having an open center, which have been used to pump water on farms for many years, and are still seen today.

These turbines with extended blades generally provided fairly high torque at low wind speeds because of their numerous blades, although they operated at lower speeds than common turbines creating electric power using airflow type blades.

However, they generally have a fairly large open center that does not utilize the wind or airflow in the center of the turbine.

More recently, other turbine configurations employ blades that are parallel to, and in some cases, their “eggbeater” blades are angled around the axis they rotate around. Typically they are placed vertically above the ground and have the advantage that they can catch air from any direction that is perpendicular to the axis.

However, they generally are less efficient in the conversion of low-speed wind or airflow into electrical power.

Prior, U.S. Pat. No. 8,137,052, is for driving an electrical only, and not other outputs. The center cowling assembly, as is it is called, does not operation in conjunction with an outer cowling surrounding the blades, in order to contain the center outward air so that it flow fully through the blades. In addition, it does not employ a center hole to provide airflow to cool or operate turbine elements such as a generator, sensors, electronics, mechanics or others. It does not have surface grooves to direct the wind or airflow to each blade in an optimum fashion. It also does not have the ability to move inward in order to optimize the turbine operation for different wind speed conditions, or protect the turbine during excess wind conditions.

In conventional or prior turbine designs for generating electricity, such as those that commonly employ two, three or five blades and common vertical blade designs are not fully optimized for lower-speed winds, which are more typical in most geographically accessible areas. Much of the wind received in the center of these turbines is not effectively utilized, particularly at low wind or airflow speeds.

This is because a given amount of wind against the blades portions nearer the axis, due to their shorter moment arm, do not create as much torque as that created by blade. portions farther away, having a longer moment arm similar to a lever.

In addition, since the blade portions near the axis rotate at a lower speed than the outer blade portions, the efficiency of the airflow conversion into torque or power is much less compared to the blade portions nearer the blade tips.

In the case of windmills, they generally have more blades for creating greater torque or power at lower wind or airspeeds using sail type blades. However, they have an open center that allows the air in the center to flow through the turbine where it is not utilized to turn the blades.

It should be understood that theoretical power output of a turbine drops at the cube of the wind speed, so it is desirable to have as high a wind speed as possible. However, high winds speeds do not occur all the time or in all geographically accessible locations.

### SUMMARY OF THE INVENTION

In accordance with the present invention, there is a wind turbine, windmill or power producing assembly or system. Its purpose is to capture, receive and change, transform or otherwise convert the kinetic energy of wind, airflow, or air pressure into mechanical work, force, pressure or electric power output.

In traditional axial-flow propeller type wind turbines, the wind, air or airflow near the axis generally flows straight through the center portions of the blades. Near the center axis the blades are generally wider and more angled in order to offset their lower rotational speed and shorter moment arm.

In addition, blade portions near the center provide increased overall mechanical or structural strength for supporting the outer portions of the blades. In turn, the blades at the outer periphery are narrower where they operate with a longer moment arm and at a higher speed. Airflow type blade outer ends are generally designed to rotate at a speed that is 6 or 7 times the wind speed.

Since all portions of each blade rotate around the axis at the same rotational rate each portion of a blade goes a different rotational distance, depending on how far it is from the center axis.

In a five foot diameter turbine, the blade portion that is 1 foot from the center axis goes 6.28 feet during each rotation. The blade portion that is 2 feet from the center axis goes 12.56 feet during each rotation.

The 2 foot blade portion then travels at a speed that is 2 times that of the 1 foot portion, since they are part of the same blade or otherwise connected together, and therefore, operates with greater efficiency.

Since the blade portions are wider near the axis that in turn takes up much of the space and limits the number of blades that the axis can hold. In addition, large turbines generally have a mechanism to vary the blade angles that takes up space and as a result they are generally limited to three blades or less for practical reasons.

In addition to each blade portion traveling at a different speed, depending on their distance from the axis, the rotating motion of each portion as creating by the wind or airflow results in an overall moment arm or lever action that contributes to turning the axis.

For a given force applied to a blade portion whose distance from the axis is doubled from that of another portion results in a rotating torque or force on the axis that twice the amount.

The moment arm and the resulting rotating torque on the axis created by a near axis blade portion is less than that for a portion that is farther away although the farther portions also must travel a farther distant to complete a revolution.

The overall result is that the portions of a blade near the axis provide less of the resulting torque or power supplied to the axis than portions that are farther from the axis. In addition each blade portion for a given amount of airflow if not connected to other blade portions that are closer or farther from the axis will turn the axis at a different speed for a given load on the turbine.

In small turbines the design limitations are not nearly as critical as in very large turbines. As a result the design of a small or moderate sized turbine can employ more blades and utilize other methods and techniques in order to improve the efficiency of converting the available kinetic energy in low-speed wind or airflow into work or power.

However, the well known Betz law says that the maximum energy that can be extracted from the kinetic energy of wind or airflow is about 59%, and that occurs when the wind through the turbine is slowed about 30 percent. If the turbine shows it less or more then the amount of the energy extracted is reduced.

Therefore, the optimum number blade will vary based on the nominal wind speed, the angle of the blades, their type, and the loading on the turbine. All of these factors have to be taken into account in the enclosed turbine invention.

A preferred embodiment, described herein, consists of a propeller-type horizontal axial-flow turbine that has numerous blades that are near the outer periphery or edges of the turbine, where their radius, distance or moment arm length is longer, therefore, the mechanical advantage of the resulting received wind or airflow is greater than if they were closer to the axis.

The blades receive wind or airflow directly, from a center dome or deflector that is located within their center and receives wind or airflow in the center, that is in turn is deflected outward to the blades, and from a surrounding cowling that receives wind or airflow that in turn is deflected inward to the blades, wherein the combined airflow is increased in force, speed and/or volume.

The center deflector can have a smooth surface, wherein in other cases it may employ ribs, or depressions, or both, that extend outward from near it center and are straight or curved, where each directs or feeds air to an individual blade, in order to optimize the airflow for maximum performance.

In the case of ribs or depressions they can be minimum near the center of the deflector and become more substantial as they get closer to the blades, channeling the wind and directing it to each blade.

The center deflector can be fixed or it can vary in position forward and backward on the axis, or its shape or contour can be varied in order to direct the wind to different segments or portion of the blade, for example, to blade segments or portions that are more of a wind sail at low wind speeds or those that are more of a airfoil at higher wind speed, in order to optimize the turbine output at different wind speeds or amount of airflow.

The center deflector can have a center hole to allow a portion of the airflow to flow around the generator or other output means, in order to provide cooling.

In a common configuration the diameter is about 70 percent of the diameter of the outer edge of the blades. This means that the air received from the deflector is about half of that directly received into the blades without consideration for the air received from the outer cowling or from external sources. Some of the energy of the air is reduced by the defection of the air, wherein, the amount loss is less when the deflector is longer and the front more pointed.

The outer perimeter cowling that surrounds the blades can be attached to the outer blades edges or alternatively surrounds the blades without touching the blades. The cowling is curved outward on its forward side in order to expand the amount of area in which the wind is captured or received.

An optional surrounding frame can be supplied that is square, rectangle or specifically shaped to allow its mounting or placement next to or near to man made or natural planer or other shaped structures or surfaces such as panels, walls, roofs, fences, buildings, mounds or canyon walls, that serve to support the turbine and to receive and direct secondary wind or airflow as a means to capture more wind, that in turn is funneled into the turbine to create a higher speed, torque and power output.

The cowling and frame outer edges can be rounded in order to be aerodynamic and to allow easy circular rotation of the entire turbine, including making it parallel to the airflow in order to minimize the airflow the into the turbine during excess wind or storm conditions.

In order to take advantage of changing wind directions that occur over the course of time, the turbine can employ a tail structure that turns and stabilizes the turbine with respect to the wind direction, or this can be done using a powered means such as a motor or actuator, under controller or computer control.

In turn, the deflected center wind or airflow is combined with wind or airflow captured or received directly by the turbine blades at the turbine periphery plus the wind or airflow that is deflected secondarily into the turbine from external surfaces or structures, if available, wherein the combined sources of received wind, air or airflow creates an increased torque or force than would otherwise be created.

The multiple input sources of wind or airflow are fed or directed to a number of fairly wide curved blades at the periphery, and while shaped either as curved sail-airfoils or conventional airfoils used on conventional turbines, at low-wind speeds they may operate more as wind sails that is primarily a force on the front side of the blade facing the wind, and at higher speeds may operate increasingly as a airfoil, where in addition to the force on the front, a low-pressure or vacuum is created on the front rear side, that helps pulls the blade in the direction of the rotation.

Where the curved airfoil is used herein, it is made from a flat material, such as metal or composite, that is curved towards the incoming wind or airflow at an angle, to capture wind on it forward side that in turn pushes the blade in rotation, while having some airfoil effect on back side, particularly at higher wind speeds. The same basic design is seen in common fans, even as their blade lengths generally continue to the axis, wherein, here they are of reduced length near the outer perimeter of the turbine. The use of the curved blade or conventional airfoil blade in the enclosed designs is based on the wind speeds the turbine is being used for, manufacturing and cost considerations.

The blades or blade portions are placed at an extended distance, radius or moment arm from the axis, in order to increase the mechanical advantage and the resulting force applied to the blades in order increase the work or power output for a given amount of received wind, airflow or pressure, thereby allowing the system to start and operate at low wind or airflow speeds.

The blades are close enough to each other that each blade shields to some degree the blade following behind, thereby, reducing the overall. resistance of the turbine to rotating, while also affecting the nature of the airflow pattern of each blade, and is designed, along with the number of blades, their shape and their nominal angles for optimum performance for the nominal wind or airflow conditions expected in a given environment.

The number of blades, their size, their width, their shape, their angle, and the open spacing between blades, are designed to optimize the wind resistance of the turbine for all sources and speeds of wind, air or airflow that are commonly received, in order to optimize the conversion of the wind kinetic energy to mechanical force, pressure or electric power.

The blades portions in the enclosed system are also relatively larger and more numerous than normally seen in other turbine systems in order to capture more torque at low-speed wind or airflow, without many of their mechanical and structural limitations that limit their number of blades and increase their cost in large turbines, while operating more as wind sails at low-wind speeds.

The enclosed turbine design can provide a rotational output that at the base speed and torque of the turbine, or using gears or belts the output can be stepped up for greater speed with less torque, or stepped down for less speed and higher torque, and set to a value that results in a maximum output for given turbine configurations and wind and airflow speeds.

The output can be used to drive a water pump that can be used to lift water from a well, stream or other water source for immediate use or storage, or it can be used to lift water to a height for storage and then, when needed, allowed to fall a distance to drive a water turbine that can in turn drive an electrical generator or otherwise used as a mechanical power source.

The output can be used to drive an air pressure pump, that pumps air into a tank to a high pressure, and then, when needed, the air can be released into an air pressure turbine that in turn can drive an electric generator or otherwise used as a mechanical power source or to drive a multiplicity of pneumatic-driven components or systems.

The output can be used to drive a lift, that lifts weights to a height, and then, when needed the weights can be allowed to drop while driving a mechanism that in turn can drive an electric generator or otherwise used as a mechanical power source.

Alternately, the output can be used to drive one or multiples outputs, that are the same type or different types.

It would be advantageous to provide an axial-flow turbine having extended blades or blade portions in order to provide increased torque or power output for a given amount of input wind or airflow.

It would also be advantageous to provide a turbine that has an increased or an optimum number of blades or blade portions in order to provide increased torque or power output for a given amount of input wind or airflow.

It would also be advantageous to provide a turbine that has a center deflector or dome that directs or forces wind or airflow received in the center outward to the extended blades in order to further increase the airflow in order to provide additional torque or power output.

It would also be advantageous to provide a center dome with a small center hole or orifice that would allow a small amount of wind or airflow to go through the dome that can be used to cool components such a generator, mechanical elements, electronic control elements, or control sensors.

It would also be advantageous to provide a center dome that is normal held outward by a spring mechanism so that the wind or airflow is directed into the front of the turbine blade. However, during excess winds, such as during a storm, the spring compresses so that the center dome moves inward so that the wind or airflow is directed behind the turbine blade, thereby, reducing the force on the blades and the overall turbine.

Alternatively, an actuator such as a solenoid or motor operating electronic control can move the dome outward or inward in order to maximize the turbine output or reduce the force on the blades and the overall turbine during excess wind conditions.

It would also be advantageous to provide a center dome that has groves for each blade that are near flush with the dome surface near the center of the dome, and become greater in depth as they approach the dome outer edges. In addition, they can be curved as they extend outward from center and away from the direction of the incoming airflow, in order to direct the airflow to each blade in an optimum fashion for increased torque or speed.

It would also be advantageous to provide a turbine that has an outer cowling that can contain the air directed from the center deflector and also capture wind or airflow beyond the turbine blades and direct it into the extended blade portions in order to further increase the airflow in order to provide additional torque or power output.

It would also be advantageous some embodiments to provide a turbine that has a square or rectangular frame that surrounds the outer cowling, or the outer cowling and frame are made as one element, and the frame helps capture additional air by having flat external edges or surfaces that can mounted directly against roof, wall or other surfaces in order to increase the airflow in order to provide additional torque or power output.

It would also be advantageous to provide a turbine that can receive air directly into the extended blades and that is directed by the center deflector, the outer cowling and the outer frame into the extended blades in order to further increase the airflow in order to provide additional torque or power output.

It would also be advantageous to provide a turbine that has air foil type blades, sail type blades or a combination of blade types in order to operate to create maximum speed, maximum torque or some mix of capability in order to maximize its output for a particular range of wind or airflow speed and output use and loading.

It would also be advantageous to provide a turbine that can keep the same, step up or step down the output speed or torque in order to be optimized at a given wind speed in order to efficiently drive or operate a water pump to pump water for use or storage, an air pressure pump as a means to store energy, a lift as a means to lift a weight to store energy or a generator as a means to output electrical power that can be used or stored.

Such a variable speed device would also help mitigate the effects of variable wind speeds on the turbine structure and on driven output components, thereby increasing reliability as week as overall power conversion efficiency.

Wind turbine power generation can be highly variable due to the highly variable nature of the wind. This results in a variable power source to the load, which itself may be continuous or variable. It would be desirable to provide a more consistent power source, and this can be achieved, in one embodiment as follows: Wind turbine drive an air compressor that fills a sealed tank. The sealed tank then serves as a large storage element to supply air pressure to drive such components as an electrical generator, mechanical pump, pneumatic components, etc. Thus the load if effectively buffered from the variable nature of the wind source, and the sealed tank serves as a low cost storage element that needs little or no maintenance. This is to be contrasted with a conventional wind turbine directly driving an electrical generator that requires costly, and high maintenance storage batteries that have limited storage capacity.

### BRIEF DESCRIPTION OF THE DRAWINGS

A complete understanding of the present invention may be obtained by reference to the accompanying drawings, when considered in conjunction with the subsequent, detailed description, in which:

FIG. 2 is a front view of a turbine without a surrounding external frame;

FIG. 3 is a sectional side view of a turbine with an surrounding external frame;

FIG. 1 is a sectional cross view of a turbine without a surrounding external frame; and

FIG. 4 is a front view of a turbine with a surrounding external frame.

For purposes of clarity and brevity, like elements and components will bear the same designations and numbering throughout the Figures.

### DESCRIPTION OF THE PREFERRED EMBODIMENT

FIG. 1 is a is a side cross view in accordance with the invention without an external frame, consisting of center dome 10 10, extended blades 18 20, surrounding cowling 12 30, mounting plate 40, axis 60 mechanical output, generator 50 or other means of power or power storage output, with mount 70 and tail 80.

The center dome 10 10 serves to receive wind or airflow and then deflect it outward to the extended blades 18 20.

The surrounding cowling 12 30 serves to receive wind beyond the blades and deflect it inward to the extended blades 18 and also contain the air deflected outward by the center dome 10 10.

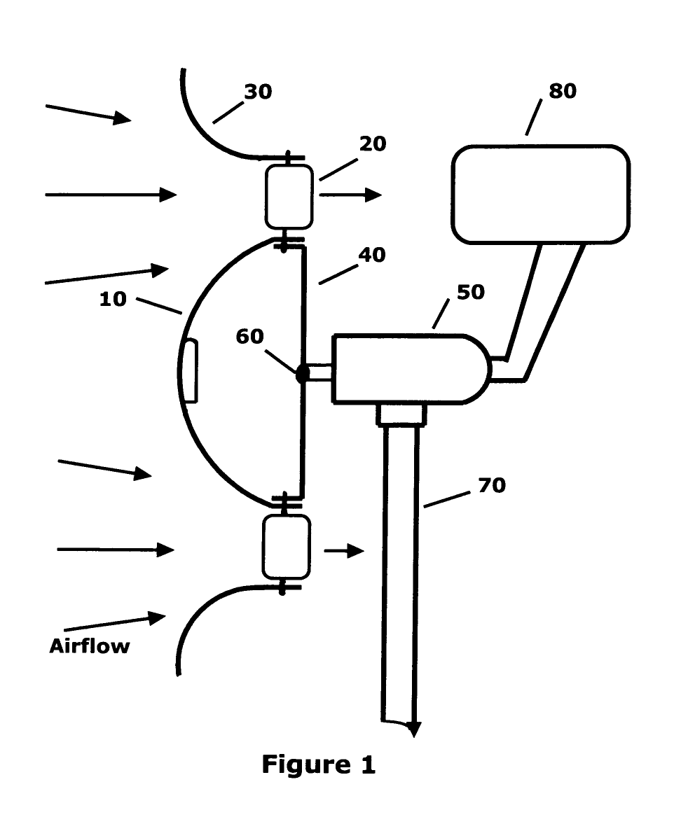

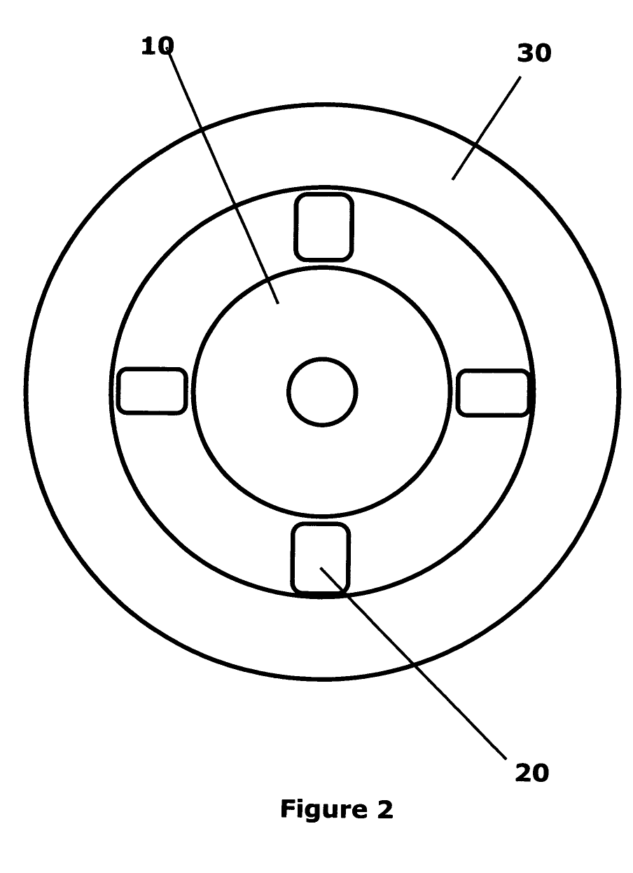

FIG. 2 is a front view in accordance with the invention without an external frame, showing center dome 10 10, extended blades 18 10, surrounding cowling 12 30 with mount 70.

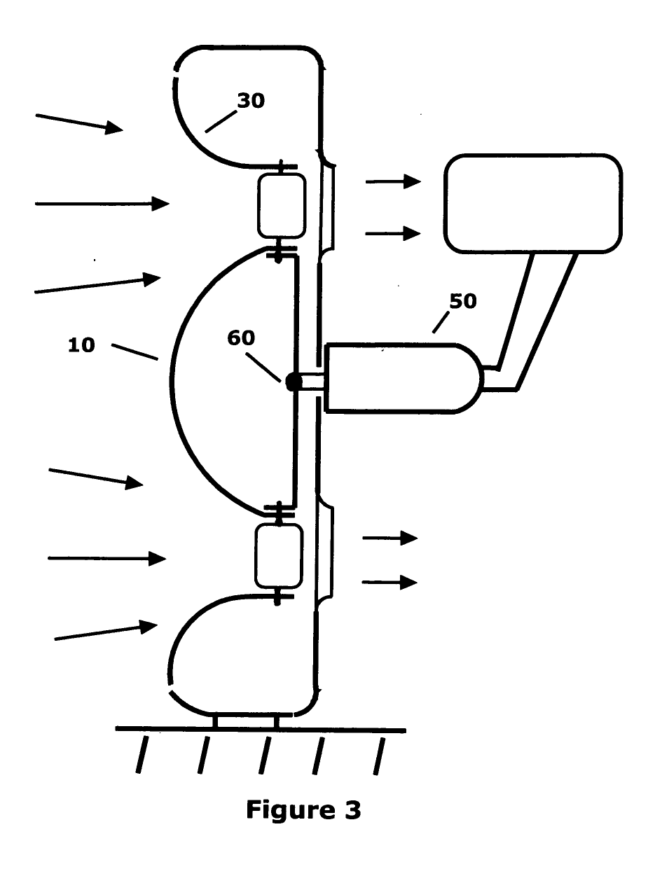

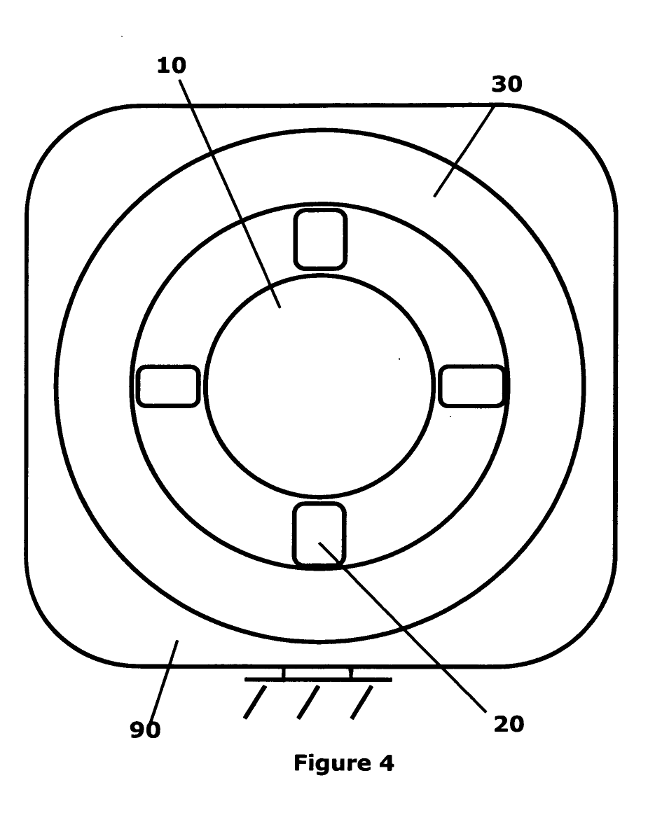

FIG. 3 is a side cross view in accordance with the invention with an external frame, consisting of center dome 10 10, extended blades 18 20, surrounding cowling 12 30, mounting plate 40, axis 60 mechanical output, or other means or power or power storage output, with external frame 90.

FIG. 4 is front view in accordance with the invention with an external frame, showing center dome 10 10, extended blades 18 20, surrounding cowling 12 30 and outer frame 90

Not shown in the FIG. 1,2 3 or 4 is a grill that can be placed on the front of the turbine or on the rear in order to protect people, animals, and birds from being harmed by the turbine, along with other means if desired.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A high-torque wind turbine for a high-torque wind turbine that more effectively captures and utilizes wind or airflow at low to moderate speeds, comprising:
means for deflecting wind or airflow in the center of the turbine outward to extended blades;
means for deflecting external wind or airflow received beyond the turbine and that deflected outward by the center dome into the extended blades;
means for outputting the turbine power that can be used to operate a water pump, an air pump, a mechanical lift, an electrical generator or other output;
means for providing an electrical output, rigidly connected to said means for outputting the turbine power that can be used to operate a water pump, an air pump, a mechanical lift, an electrical generator or other output; and
means for converting wind or airflow received directly, from by the external cowling, or from the center dome and converting its kinetic energy into mechanical power, rigidly connected to said means for outputting the turbine power that can be used to operate a water pump, an air pump, a mechanical lift, an electrical generator or other output, exteriorly positioned to said means for deflecting external wind or airflow received beyond the turbine and that deflected outward by the center dome into the extended blades, and structurally coupled to said means for deflecting wind or airflow in the center of the turbine outward to extended blades.

2. The high-torque wind turbine in accordance with claim 1, wherein said means for deflecting wind or airflow in the center of the turbine outward to extended blades comprises a center dome.

3. The high-torque wind turbine in accordance with claim 1, wherein said means for deflecting external wind or airflow received beyond the turbine and that deflected outward by the center dome into the extended blades comprises a surrounding cowling.

4. The high-torque wind turbine in accordance with claim 1, wherein said means for outputting the turbine power that can be used to operate a water pump, an air pump, a mechanical lift, an electrical generator or other output comprises a turbine mechanical output.

5. The high-torque wind turbine in accordance with claim 1, wherein said means for providing an electrical output comprises an electrical generator.

6. The high-torque wind turbine in accordance with claim 1, wherein said means for converting wind or airflow received directly, from by the external cowling, or from the center dome and converting its kinetic energy into mechanical power comprises an extended blades.
